(19) United States
(12) Patent Application Publication
(10) Pub. No.: US 2026/0147600 A1
(43) Pub. Date: May 28, 2026

(54) REMOTE CONSOLE FOR VIRTUAL MACHINES IN A CLOUD COMPUTING PLATFORM

(71) Applicant: Akamai Technologies, Inc., Cambridge, MA (US)

(72) Inventors: Philip A. Lisiecki, Santa Barbara, CA (US); Christiaan Lutzer, Sharon, MA (US); Igor Lubashev, Arlington, MA (US)

(21) Appl. No.: 18/962,268

(22) Filed: Nov. 27, 2024

(51) Int. Cl. G06F 9/455; H04L 9/40; H04L 67/10

(52) U.S. Cl. CPC G06F 9/45558; H04L 63/08; H04L 67/10; G06F 2009/45595

(57) ABSTRACT

A cloud computing platform provides virtual machines on-demand to users. The platform provides a service that enables the user to access and control their virtual machine via an out-of-band channel for administrative purposes. A user invokes this service by authenticating with a control center and receiving a URL that points to a content delivery network (CDN). The user follows the URL to connect to a particular CDN server, per the CDN's request routing architecture. The CDN server applies instructions for handling this cloud compute platform URL, thereby decrypting an encrypted token in the URL to find, e.g., a network locator pointing to the host that is currently hosting the user's virtual machine, as well as an identifier for the user's virtual machine, and authenticators. The CDN server goes forward to the host, connecting to an endpoint which in turn connects to the user's virtual machine to provide the service.

### BACKGROUND

### Technical Field

This patent document generally relates to cloud computing services.

### Brief Description of the Related Art

Distributed computer systems are well-known in the prior art. One such distributed computer system is a “content delivery network” (CDN) or “overlay network” that is operated and managed by a service provider. The service provider typically provides the content delivery service on behalf of third parties (customers) who use the service provider's shared infrastructure. A distributed system of this type typically refers to a collection of autonomous computers linked by a network or networks, together with the software, systems, protocols and techniques designed to facilitate various services, such as content delivery, web application acceleration, or other support of outsourced origin site infrastructure. A CDN service provider typically provides service delivery through digital properties (such as a website), which are provisioned in a customer portal and then deployed to the network.

Cloud computing is an information technology delivery model by which shared resources, software and information are provided on-demand over a network (e.g., the publicly-routed Internet) to computers and other devices of customers. This type of delivery model has significant advantages in that it reduces information technology costs and complexities, while at the same time improving workload optimization and service delivery. In a typical use case, an application is hosted from network-based resources and is accessible through a conventional browser or mobile application. Cloud compute resources typically are deployed and supported in data centers that run one or more network applications, typically using a virtualized architecture wherein applications run inside virtual servers, or virtual machines (VMs), which are mapped onto physical servers in the data center. The virtual machines typically run on top of a hypervisor, which allocates physical resources to the virtual machines.

As part of provisioning a new virtual machine, the platform can assign it a public IP address. With this public IP address, an administrative user can access and control the virtual machine, typically through a program referred to as a shell. The shell enables the user to interact with their virtual machine's operating system, including its file and process management and configuration capabilities.

It can be useful, and even necessary, to provide an alternative methodology for the user to access and control their virtual machine. For example, a user might misconfigure their virtual machine such that it is not reachable at its public assigned IP address. To this end, it is known in the prior art for a cloud computing platform to provide an “out-of-band” access and control mechanism allowing users to contact the virtual machine through the platform's services and through a back-end administrative IP address. This may be thought of as a remote console provided through out-of-band text and/or graphical interfaces.

In the prior art, there are several known methodologies for providing out-of-band access and control services. The simplest way is to have a user's client device connect directly to the host that contains their virtual machine. Through a central management interface, the user obtains the hostname of the host running their VM, and configures a set of credentials (e.g., username/password) for a restricted user account on the host. The user can make a secure shell (SSH) connection to the host using those credentials. SSH is a standard internet protocol. The host operating system then connects to an emulator and virtualizer for the virtual machine, such as QEMU. In one implementation, a GNU screen process is used to wrap the emulation process and expose a serial port, hence providing the user with a serial terminal emulator through which they may interface with their virtual machine via text based commands.

To improve the foregoing approach, a special SSH-compliant server can be deployed into each data center. This is referred to as a shell session server. This shell session server runs in its own virtual machine. That virtual machine is sometimes referred to as an infrastructure VM, because it is not a guest VM for a customer but rather part of the compute platform's operational resources. The user then connects to this shell session server, knowing that they have virtual machines somewhere in that data center. The shell session server interacts with back-end APIs to authenticate the user's credentials and to learn the hostname and administrative IP address of the host that has the user's virtual machine, as well as the identifiers for the virtual machine itself. The shell session server may present an interface to the user through which the customer can query and view the virtual machines they have in that data center, and choose to connect to one. The shell session server then makes the connection to the virtual machine on the host using the administrative IP address and proxies the communications between client and virtual machine.

An improvement to the foregoing approach was to have the user log in to a cloud manager (a web based UI), which (upon successful authentication) gives them a URL with a hostname resolving to the IP address of the shell session server in the correct data center, and an encrypted, time-limited token to use for connecting to that shell session server. The token encrypts the user identification and the VM it is valid for. The user presents this token to the shell session server, which validates it, locates the VM on a given host, and connects the user to the VM.

A web-based alternative involves a user agent (e.g., browser or an AJAX application) connecting to a web-based control center to authenticate and receive an encrypted token. As before, the user logs in to a cloud manager (a web based UI), which (upon successful authentication) gives them a URL with the IP address of the shell session server in the correct data center. The user connects to the shell session server in the data center, and upgrades from HTTP to websockets. The shell session server extracts credentials from the token and validates the token with the back-end APIs. As before, it then uses the back end API to learn the hostname and administrative IP address of the host that has the customer's virtual machine. The shell session server then can export the SSH data from the host to this websockets session.

A graphical interface can be provided by using a VNC client or web-based noVNC client leveraging Javascript code downloaded into the user's browser from the control center. In this option, the shell session server in the data center creates a VNC session with the virtual machine's VGA port on the host, which can be exposed by QEMU through a websocket. In this way, the user's device can send mouse and keyboard data, while receiving graphics data from the virtual machine in a VNC data stream over websockets.

A final alternative is to provide a web-page interface. In this approach, the user again connects to a web-based control center through an HTTP/websockets session. As explained before, the shell session server establishes a session to the virtual machine's screen/QEMU session on the host. That provides a text-based terminal, as mentioned before. But in this case, the user's browser is served with a Javascript application that converts the text commands and codes from the websockets stream into HTML and CSS, so the user is viewing a web page console for their virtual machine.

In practice, the aforementioned shell session server in the data center can support all of the foregoing methodologies to provide a rich set of terminal options. All of the foregoing methodologies therefore constitute prior art known by others.

While the foregoing methodologies are valuable, it is desirable to avoid the need to run special infrastructure in data centers and specifically the shell session server described above. This desire is especially acute for cloud computing platforms that evolve from footprints that are exclusively in large centralized “core” data centers to more widely distributed approaches. In the new paradigm, many cloud computing deployments may be in smaller data centers or deployed at the edge of end user access networks in ISPs. Requiring special infrastructure for every such deployment is neither scalable nor cost-effective.

The first methodology above saw each host itself providing a SSH service for VMs hosted locally. That approach did not require special infrastructure VMs, but still left flexibility concerns, as it required a user knowing which host to connect to. Moreover, it posed a security risk, as it exposed the administrative IP addresses and access to associated back-end interfaces of the hosts in the cloud computing platform.

The teachings hereof address these and other needs that will become apparent to those skilled in the art upon review of the subject matter disclosed herein.

The teachings presented herein improve the functioning of a computer system itself, providing new and improved methodologies for out-of-band access and control of virtual resources and for managing access to virtual resources in a multi-tenant platform. Those skilled in the art will understand these and other improvements from the teachings hereof.

### BRIEF SUMMARY

This section describes some pertinent aspects of this invention. Those aspects are illustrative, not exhaustive, and they are not a definition of the invention.

A multi-tenant cloud computing platform provides resources on-demand over a network for users. The resources are virtualized wherein a customer's applications run inside their own virtual machine. The platform provides a service that enables a customer's administrative user to access and control the virtual machine via an out-of-band channel. The service runs not on special infrastructure but on every host in the cloud computing platform. Each host's instance of the service provides access to the virtual machines running locally on that host. A distributed platform of proxy servers, specifically a CDN platform, is used to locate and provide secure access to the correct instance of the service in the correct virtual machine and data center. In this way, preferably, the data plane of the CDN is used to facilitate the control plane of this out-of-band service for the cloud computing platform.

A user invokes this service by authenticating to a control center through their user agent (e.g., their browser or app). Upon successful authentication, the control center issues an encrypted token along with information needed to contact a content delivery network (CDN) having a distributed set of proxy servers. The encrypted token can be included in the URL path or as a parameter. The information needed to contact the CDN is preferably a URL. The URL has a hostname that is associated with the CDN's authoritative DNS infrastructure. When the hostname is resolved through such DNS infrastructure, it returns an IP address of a particular proxy server, or an Anycast IP address that is routed to a particular proxy server.

The user agent generates a request to the URL and is connected by the CDN to a particular proxy server, which the CDN typically selects to be close to the user agent and not overloaded (among other factors). Upon receipt of the request, the chosen proxy server applies a configuration that specifies how to handle requests made to the URL. For this special “cloud compute platform” URL, the configuration instructs the proxy server to decode the encrypted token and find a network locator pointing to the host that is currently hosting the customer's virtual machine, as well as an identifier for the customer's virtual machine itself. Preferably, the network locator is an IP address for the host or a hostname that can be resolved to such IP address.

The proxy server makes a forward connection to the host as origin. More specifically, the proxy server leverages the network locator to contact the host and to connect to the service endpoint (e.g., the application) that provides the access and control functionality. The particular proxy server passes the virtual machine identifier to the service endpoint, which connects to the virtual machine (e.g., to the serial or graphical port exposed by QEMU or other emulation software). Commands, responses, event notifications, and other messages are then carried by the proxy server to and from the user agent in this communication channel in a full duplex fashion.

The claims are incorporated by reference into this section, in their entirety.

### BRIEF DESCRIPTION OF THE DRAWINGS

The invention will be more fully understood from the following detailed description taken in conjunction with the accompanying drawings, in which:

FIG. 1 is a diagram illustrating a distributed system configured as a content delivery network (CDN), in accordance with one embodiment of the teachings hereof;

FIG. 2 is a diagram illustrating an implementation of a server machine such as 102 in FIG. 1, in accordance with one embodiment of the teachings hereof;

FIG. 3 is a diagram of a data center and a guest virtual machine, in accordance with one embodiment of the teachings hereof;

FIG. 4 is a diagram of a data center in a cloud computing platform, in accordance with one embodiment of the teachings hereof;

FIG. 5 is a diagram of a control plane for a cloud computing platform, in accordance with one embodiment of the teachings hereof;

FIG. 6 is a diagram of a generalized edge compute system, in accordance with one embodiment of the teachings hereof;

FIG. 7 is a diagram illustrating a methodology for a user to access and control their VM, in accordance with one embodiment of the teachings hereof; and,

FIG. 8 is a block diagram illustrating hardware in a computer system that may be used to implement the teachings hereof.

Numerical labels are provided in some FIGURES solely to assist in identifying elements being described in the text; no significance should be attributed to the numbering unless explicitly stated otherwise.

### DETAILED DESCRIPTION

The following description sets forth embodiments of the invention to provide an overall understanding of the principles of the structure, function, manufacture, and use of the methods and apparatus disclosed herein. The systems, methods and apparatus described in this application and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present invention. All patents, patent application publications, other publications, and references cited anywhere in this document are expressly incorporated herein by reference in their entirety, and for all purposes. The term “e.g.” used throughout is used as an abbreviation for the non-limiting phrase “for example.”

The teachings hereof may be realized in a variety of systems, methods, apparatus, and non-transitory computer-readable media. It should also be noted that the allocation of functions to particular machines is not limiting, as the functions recited herein may be combined or split amongst different hosts in a variety of ways.

Any reference to advantages or benefits refer to potential advantages and benefits that may be obtained through practice of the teachings hereof. It is not necessary to obtain such advantages and benefits in order to practice the teachings hereof.

All references to HTTP should be interpreted to include an embodiment using encryption (HTTP/S), such as when TLS secured connections are established. While context may indicate the hardware or the software exclusively, should such distinction be appropriate, the teachings hereof can be implemented in any combination of hardware and software. Hardware may be actual or virtual.

### Content Delivery Network

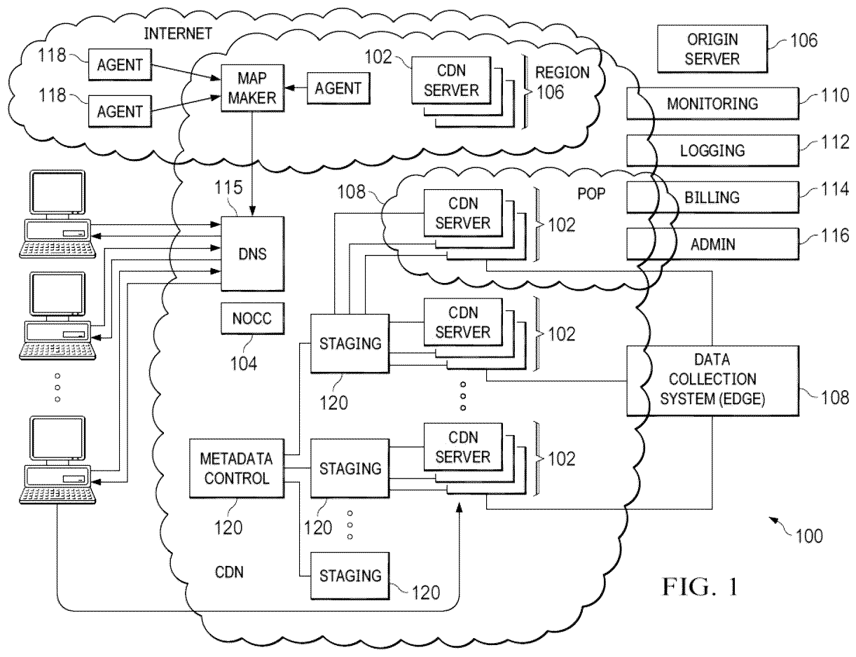

In a known system, such as shown in FIG. 1, a distributed computer system 100 is configured as a content delivery network (CDN) and is assumed to have a set of machines 102a-n distributed around the Internet. Typically, most of the machines are servers located near the edge of the Internet, i.e., at or adjacent end user access networks. A network operations command center (NOCC) 104 manages operations of the various machines in the system. Third party sites, such as web site 106, offload delivery of content (e.g., HTML, embedded page objects, streaming media, software downloads, and the like) to the distributed computer system 100 and, in particular, to the CDN's servers. Generally, the servers are configured as caching proxy servers, as will be described in more detail below. Typically, content providers offload their content delivery by aliasing (e.g., by a DNS CNAME) given content provider domains or sub-domains to domains that are managed by the service provider's authoritative domain name service. End users that desire the content are directed to the distributed computer system to obtain that content more reliably and efficiently. It is also possible to use Anycast techniques by advertising a single IP address from multiple points on the Internet, enabling BGP to route packets to the nearest point of presence.

The CDN servers 102 are typically located at locations that are publicly-routable on the Internet, in end-user access networks, peering points, within or adjacent nodes that are located in mobile networks, in or adjacent enterprise-based private networks, or in any combination thereof.

Typically, content providers offload their content delivery by aliasing (e.g., by a DNS CNAME) given content provider domains or sub-domains to domains that are managed by the service provider's authoritative domain name service. The service provider's domain name service directs end user client machines 122 that desire content to the distributed computer system (or more particularly, to one of the CDN servers in the platform) to obtain the content more reliably and efficiently. The CDN servers 102 provide a proxy server function, responding to the client requests for example by fetching requested content from a local cache, from another CDN server, going forward to the origin server 106 associated with the content provider, or other source, and providing it to the requesting client.

For cacheable content, CDN servers 102 typically employ a caching model that relies on setting a time-to-live (TTL) for each cacheable object. After it is fetched, the object may be stored locally at a given CDN server until the TTL expires, at which time is typically re-validated or refreshed from the origin server 106. For non-cacheable objects (sometimes referred to as ‘dynamic’ content), the CDN server typically returns to the origin server 106 time when the object is requested by a client. The CDN may operate a server cache hierarchy to provide intermediate caching of customer content in various CDN servers that are between the CDN server handling a client request and the origin server 106; one such cache hierarchy subsystem is described in U.S. Pat. No. 7,376,716, the disclosure of which is incorporated herein by reference.

Although not shown in detail, the distributed computer system may also include other infrastructure, such as a distributed data collection system 108 that collects usage and other data from the CDN servers, aggregates that data across a region or set of regions, and passes that data to other back-end systems 110, 112, 114 and 116 to facilitate monitoring, logging, alerts, billing, management and other operational and administrative functions. Distributed network agents 118 monitor the network as well as the server loads and provide network, traffic and load data to a DNS query handling mechanism 115, which is authoritative for content domains being managed by the CDN. A distributed data transport mechanism 120 may be used to distribute control information (e.g., metadata to manage content, to facilitate load balancing, and the like) to the edge servers.

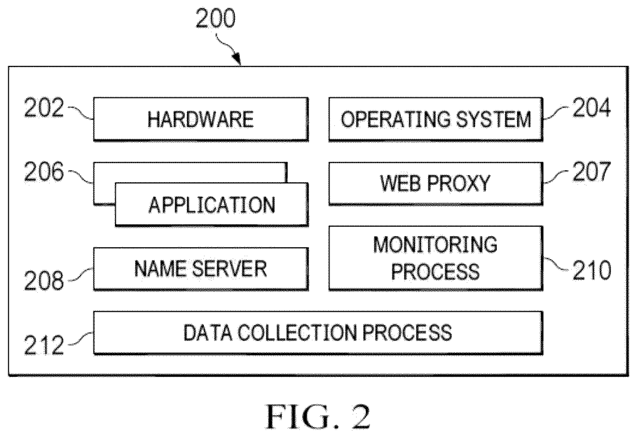

As illustrated in FIG. 2, a given machine 200 comprises commodity hardware 202 running an operating system kernel (such as Linux or variant) 204 that supports one or more applications 206a-n. To facilitate content delivery services, for example, given machines typically run a set of applications, such as an HTTP proxy 207 (sometimes referred to as a “global host” process), a name server 208, a local monitoring process 210, a distributed data collection process 212, and the like.

A CDN server is configured to provide one or more extended content delivery features, preferably on a domain-specific, customer-specific basis, preferably using configuration files that are distributed to the servers using a configuration system. A given configuration file preferably is XML-based and includes a set of content handling rules and directives that facilitate one or more advanced content handling features. The configuration file may be delivered to the CDN server via the data transport mechanism. U.S. Pat. No. 7,111,057 illustrates a useful infrastructure for delivering and managing proxy server content control information, and this and other edge server control information can be provisioned by the CDN service provider itself, or (via an extranet or the like) the content provider customer who operates the origin server.

The CDN may include a storage subsystem, such as described in U.S. Pat. No. 7,472,178. The CDN may operate a server cache hierarchy to provide intermediate caching of customer content; one such cache hierarchy subsystem is described in U.S. Pat. No. 7,376,716.

The CDN may provide secure content delivery among a client browser, edge server and customer origin server in the manner described in U.S. Publication No. 2004/0093419. Secure content delivery as described therein enforces SSL-based links between the client and the edge server process, on the one hand, and between the edge server process and an origin server process, on the other hand. This enables an TLS-protected web page and/or components thereof to be delivered via the edge server. To enhance security, the service provider may provide additional security associated with the edge servers. This may include operating secure edge regions comprising edge servers located in locked cages that are monitored by security cameras.

As an overlay, the CDN resources may be used to facilitate wide area network (WAN) acceleration services between enterprise data centers (which may be privately-managed) and third party software-as-a-service (SaaS) providers.

As mentioned, in a typical operation, a content provider identifies a content provider domain or sub-domain that it desires to have served by the CDN. The CDN service provider associates (e.g., via a canonical name, or CNAME) the content provider domain with an edge network (CDN) hostname, and the CDN provider then provides that edge network hostname to the content provider. When a DNS query to the content provider domain or sub-domain is received at the content provider's domain name servers, those servers respond by returning the edge network hostname. The edge network hostname points to the CDN, and that edge network hostname is then resolved through the CDN name service. To that end, the CDN name service returns one or more IP addresses. The requesting client browser then makes a content request (e.g., via HTTP or HTTPS) to an edge server associated with the IP address. The request includes a host header that includes the original content provider domain or sub-domain. Upon receipt of the request with the host header, the edge server checks its configuration file to determine whether the content domain or sub-domain requested is actually being handled by the CDN. If so, the edge server applies its content handling rules and directives for that domain or sub-domain as specified in the configuration. These content handling rules and directives may be located within an XML-based “metadata” configuration file.

More generally, the techniques described above are provided using a set of one or more computing-related entities (systems, machines, processes, programs, libraries, functions, or the like) that together facilitate or provide the functionality described above. In a typical implementation, a representative machine on which the software executes comprises commodity hardware, an operating system, an application runtime environment, and a set of applications or processes and associated data, which provide the functionality of a given system or subsystem. As described, the functionality may be implemented in a standalone machine, or across a distributed set of machines. The functionality may be provided as a service, e.g., as a SaaS solution.

Because the CDN infrastructure (or “platform”) is shared by multiple third parties, it is sometimes referred to herein as a multi-tenant shared infrastructure. The CDN processes may be located at nodes that are publicly-routable on the Internet, within or adjacent nodes that are located in mobile networks, in or adjacent enterprise-based private networks, or in any combination thereof.

As used herein, an “CDN server” refers to a CDN (overlay network) machine or server process used thereon. In the above-described context, a “region” typically is a set of servers or machines that are co-located with one another. More formally, a “region” or “cluster” typically is a collection of machines in a single location within a given region that share equivalent front-end network connectivity and also share a local back-end network. A set of such regions and associated network infrastructure (e.g., within a metropolitan area or “metro”) which shares connectivity to the Internet is sometimes referred to herein as an Equivalence-Class-Of-Region (“ECOR”). There may be multiple ECORs in any given city (although there may be cases where an ECOR spans physical nearby buildings, such as with DWDM interconnects).

The platform as described is a deployed network designed to manage large numbers of distributed servers in a distributed fashion. To this end, and in one non-limiting embodiment, the platform leverages an underlying Linux-based operating system (OS) (e.g., a Linux kernel version that is Ubuntu-based). A Linux kernel version of this type (sometimes referred to herein as Linux Server Install (LSI)) may have one or more supporting services such as log aggregation, data aggregation and query reporting, secret management, and the like. Using the LSI and its related services, the system provides for: deploying and managing servers at scale; role-based and standards-compliant remote access control and audit functionality; a secret management system for distributing key materials; a Network Operations Control Center (NOCC) for tooling and expertise managing systems; a platform that incorporates ways to distribute critical control information with multiple safety features built-in, and techniques for keeping server BIOS and firmware up-to-date. The LSI is readily patched and features can be added thereto as needed.

More information about CDN technologies, including examples of request routing mechanisms using DNS and otherwise, as well as proxy server technologies, can be found in the following documents, the teachings of which are hereby incorporated by reference in their entireties: U.S. Pat. Nos. 6,108,703; 7,293,093; 7,096,263; 7,096,266; 7,484,002; 7,523,181; 7,574,499; 7,240,100; 7,603,439; 7,725,602; 7,716,367; 7,996,531; 7,925,713; 7,058,706; 7,251,688; 7,274,658; 7,912,978; 8,195,831.

### Cloud Computing

As mentioned, cloud computing is a model of service delivery for enabling on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. Available services models that may be leveraged in whole or in part include: Software as a Service (SaaS) (the provider's applications running on cloud infrastructure); Platform as a service (PaaS) (the customer deploys applications that may be created using provider tools onto the cloud infrastructure); Infrastructure as a Service (IaaS) (customer provisions its own processing, storage, networks and other computing resources and can deploy and run operating systems and applications). Typically, the cloud computing environment has a set of high level functional components that include a front end identity manager, a business support services (BSS) function component, an operational support services (OSS) function component, and the compute cloud components themselves.

A representative cloud computing infrastructure is implemented in a data center operated by a virtual machine (VM) hosting provider. A representative provider is Linode®, now owned by Akamai Technologies, Inc., of Cambridge, Massachusetts. In this infrastructure, a “host” refers to a bare-metal machine running software. A “compute host” is a machine that manages virtual machines VMs and typically runs associated administrative software for a cloud compute infrastructure. A “guest VM” is a virtual machine running on a Compute Host, and it may be a customer (guest) VM or an infrastructure VM. A “Datacenter” (DC) typically is a customer-facing abstraction for cloud compute infrastructure, typically a cluster of guest VMs.

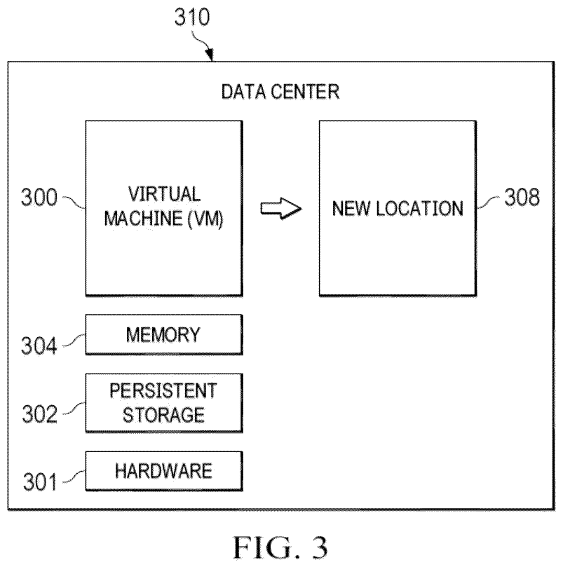

A representative VM in a datacenter 310 is depicted in FIG. 3. The VM 300 has associated therewith persistent storage 302, the amount of which typically varies based on size and type, and memory (RAM) 304. The local persistent storage typically is built on enterprise-grade SSDs (solid state disks). The VM's persistent storage space can be allocated to individual disks. Disks can be used to store any data, including the operating system, applications, and files. A representative VM is equipped with two (2) disks, a large primary disk used to store the OS distribution (typically Linux), software, and data, and a smaller swap disk, which is used in the event the VM runs out of memory. While two disks are typical, the VM can be configured to have many more disks, which can serve a variety of purposes including dedicated file storage or switching between entirely different Linux distributions. When multiple disks are added to a VM, configuration profiles are used to determine the disks that are accessible when the VM is powered on, as well as which of those disks serves as a primary root disk. Using tools provided by the service provider, disks can be created, resized, cloned and deleted. In addition, and by using a cloud manager, the VM can be migrated to another data center (if the provider operates multiple data centers), or to another host within the datacenter 308.

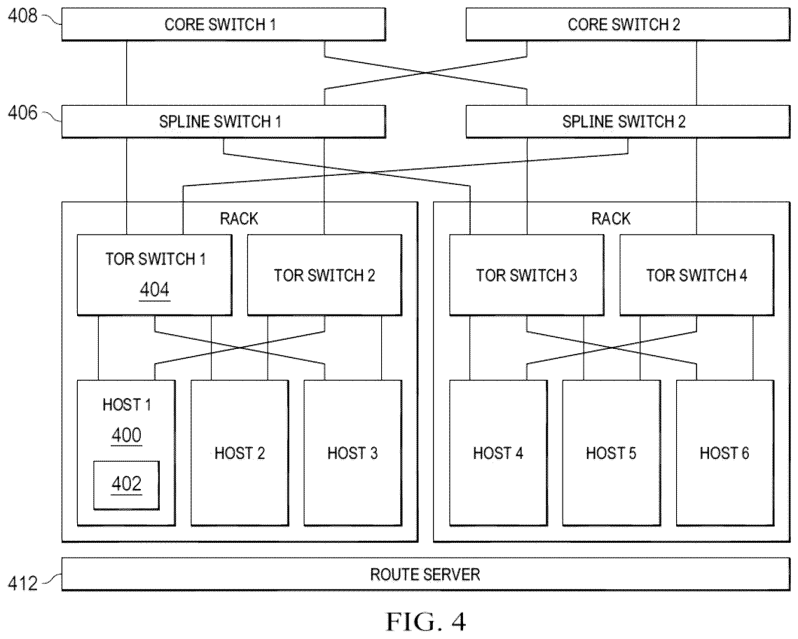

FIG. 4 depicts a representative core site (a data center) that supports a known cloud compute infrastructure. As depicted, this architecture is based on a non-blocking, multistage switching network (e.g., CLOS) with Border Gateway Protocol (BGP) as the routing protocol between switches. As depicted, the Hosts 400 are physical boxes that contain the Guest VMs 402. As illustrated, each host is connected with two TOR (Top-Of-Rack) switches 404 with one physical ethernet cable to each of them. A Top-of-Rack router or switch is a network that provides connectivity between Hosts in a rack and between those Hosts and the rest of a network fabric, transit, or other such connectivity. Upstream (north) of the ToR is a set of leaf or bolt routers, in this example spine 406 and core 408 switches, which connect to the core switches 410. Routing between hosts and switches is done through BGP; all switches and hosts speak BGP with switches and hosts they have a physical connection with. In addition, typically the hosts 400 have an eBGP connection with one or more instances of a route server 412, which acts as a distributed network controller. The route server 412 may execute a route server manager process that performs leader election and starts/stops route server instances as needed. The hosts 400 use an Internet routing protocol suite (e.g., FRR or FRRouting) to establish eBGP connections to the TORs and route servers and install routes in the Linux kernel.

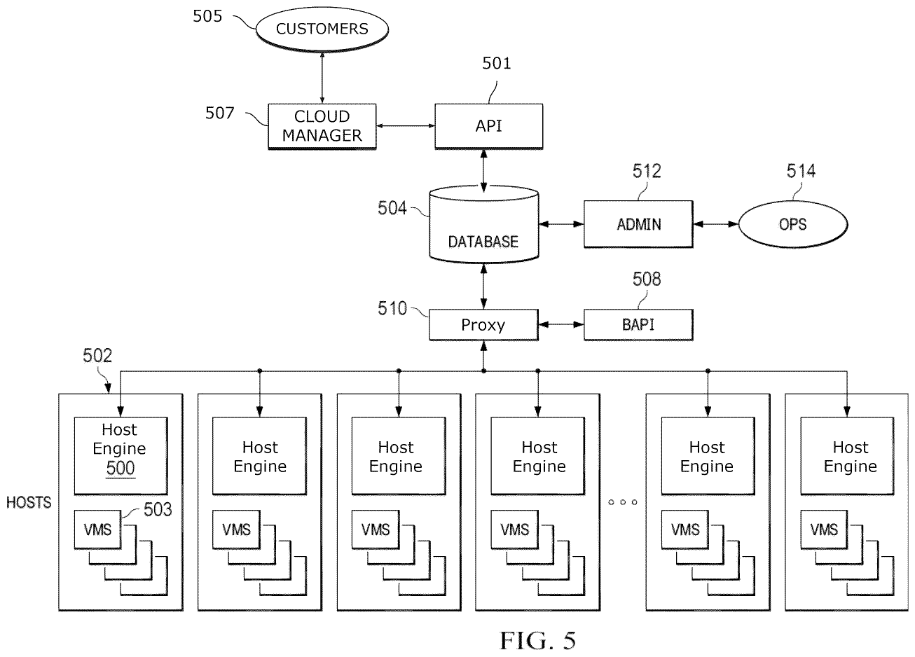

The above-described core site is managed by a control plane that is now described and depicted with reference to FIG. 5. In a representative embodiment, a core site runs a software package that operates as a host engine 500. The host engine 500 manages virtual machines (among other things) on a host 502. The host engine 502 interoperates with a network-accessible database 504, which may be located remotely from the host.

The host engine 500 takes jobs from a job table to, e.g., create, delete, move, or otherwise manage VMs on the local host. Such jobs are created by an API in conjunction with an allocator. The allocator is the control plane component that is responsible for placing workloads onto available hardware. The job of the allocator, which may be implemented in the form of a Python function (e.g., get host), is to balance load across hardware in a customer-selected compute region, and to ensure that IP addresses, disk space, CPU, memory and other constrained machine resources, all have availability to accept the new workload. The database 504, which may be implemented as any number of known SQL instances, is a singleton that acts both as a data source and as a message bus. In particular, the database 504 acts as a message bus among end users interacting with the cloud compute service (typically accessed at a secure network-accessible domain), the allocator making VM placement decisions, and one or more other compute infrastructure hosts performing jobs in service of end user requests. For example, when a customer 505 (via user agent) creates a guest VM on the compute service, a series of jobs are inserted into the database 504 with a Host Identifier (Host ID) selected by the allocator. When that host wakes up from sleeping and looks for work in the database 504, it finds those jobs and starts executing on them. As a result, the compute host 502 here creates the guest VM, sets up its volumes and networks, and boots the guest VM with QEMU. QEMU is a generic and open source machine emulator and virtualizer. It emulates a computer's processor through dynamic binary translation and provides a set of different hardware and device models for the machine, enabling it to run a variety of guest operating systems. It can interoperate with Kernel-based Virtual Machine (KVM) to run virtual machines at near-native speed, and it can also emulate user-level processes, allowing applications compiled for one processor architecture to run on another. QEMU also has a migration framework that the host engine uses to move a guest VM from machine to machine. Error handling and observability are all sent back to the database 504 and reflected in a service user interface (UI) dashboard (cloud manager 507). Cloud manager 507 is in communication with the database 504 via an API 501. The API 501 may also be exposed such that customers 505 can integrate with the platform without using the cloud manager UI 507, in alternative embodiments.

Within this service, the datacenter acts as a compute boundary. In an example implementation, a service datacenter then is a formal entity in the database 504 and is the boundary into which customers select and deploy compute. As also shown, the site may include a Back-end Application Programming Interface (BAPI) 508 that is used by various components in the platform. A caching proxy layer 510 may be implemented in between the database and hosts for scalability and resilience. The system can also include data collector components (e.g., which may run on behalf of the database 504) that collect individual VM statistics that are used as the data source of the Analytics tab in a Cloud Manager 507 web based UI.

In a representative embodiment, the control plane described above is managed “as-a-service” from a secure web application available, e.g., from a service provider domain or subdomain. After becoming a customer, secure permissioned access to the control plane is provided to enable the customer to provision and manage its workloads in the compute infrastructure.

### Generalized Edge Compute

According to a first feature of this disclosure, virtual machine provisioning and management by the above-described control plane is configured in one or more edge sites hosted within overlay network (e.g., CDN) regions and ECORs. More formally, Generalized Edge Compute (GEC) as provided herein includes the notion of migrating compute instances such as depicted in FIG. 5 out of a core site (e.g., a datacenter) and into locations within the overlay network edge, e.g., in edge access networks including, without limitation, those networks in metropolitan areas, in emerging markets, and the like. In so doing, the techniques herein address the goal of bringing compute closer to the user, which is a core value proposition of well-designed and implemented overlay network solutions. To this end, and in one embodiment, GEC comprises a host engine running on overlay network edge hardware and software (e.g., LSI) for the purposes of supporting generalized compute workloads. The term “generalized” in this context implies both compute that is not tied to the delivery of objects through a CDN, as well as software written in any programming language that runs within the context of a virtual machine.

Generalized Edge Compute transforms the cloud marketplace and takes cloud computing to the edge by embedding cloud computing capabilities into a highly-distributed overlay edge network. This solution combines the computing power of the cloud compute infrastructure with the proximity and efficiency of the edge to put workloads closer to users. While traditional cloud providers support VMs and containers in a relatively small number of core data centers, the approach herein extends this capability to edge Points of Presence (PoPs), bringing full stack computing power to hundreds of previously hard to reach locations. Deploying compute into an edge platform also takes advantage of existing operational tools, processes, and observability—enabling developers to innovate across the entire continuum of compute, providing a consistent experience from centralized cloud to distributed edge.

Provisioning the host engine onto the edge network enables a cloud compute solution that is highly distributed and that leverages the overlay network LSI-supported ancillary features and functions that include, without limitation, data aggregation, log aggregation, NOCC support, safety features (zones, rollbacks), compliance (PCI, etc.), secrets, reliable configuration distribution, and role-based, standards-compliant, auditable remote access.

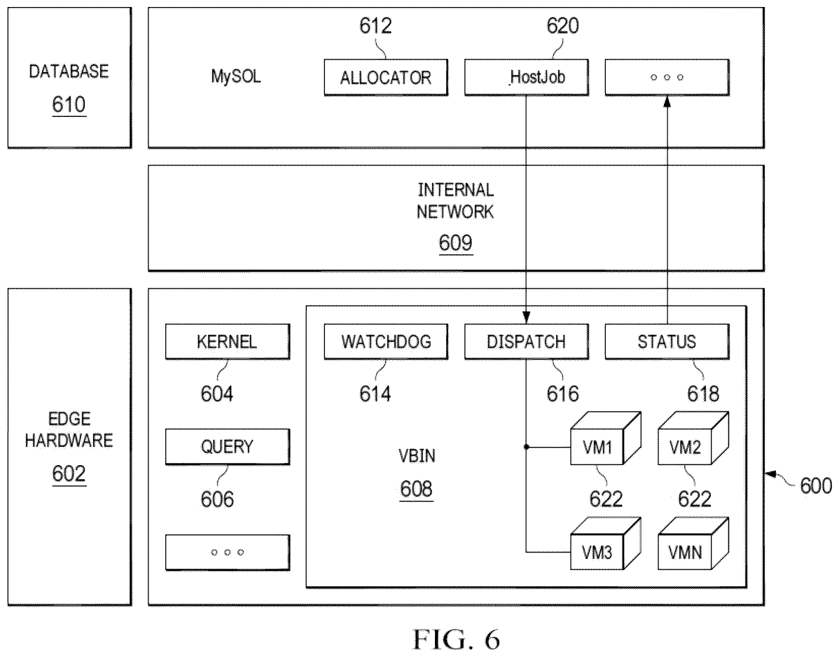

FIG. 6 depicts a representative implementation of the above-described control plane on an overlay network machine 600 which may be of the type shown in FIG. 1 (102). In this example, the edge machine 600 comprises hardware 602, and the edge machine operating system (OS) 604 and supporting services 606. Here, compute host engine 608 has been delivered to the edge machine over the internal CDN network 609, and it is configured to run on the OS 604 as previously described. As depicted, this host engine 608 interoperates and communicates with a remote database (DB) 610, which, together with the allocator 612, forms part of the cloud compute control plane. The database 610 holds configuration data and system state, and it is accessed directly by host engine 608. As previously noted, the database provides a message bus function between and among users (e.g., customers) interacting with web application compute service platform, the allocator 612 making VM placement decisions, and compute hosts (in this case host engine 608 executing on top of LSI in the overlay edge machine) performing jobs in service of those user requests. In this embodiment, the host engine 608 includes a watchdog function 614, a dispatch function 616, and a status function 618. The allocator 612 makes the VM placement decisions and enqueues a job to implement them on the host engines, one of which is shown at 608. The allocator 612 refers to a database table which for each host defines a set of “plan type” capacities, and this table is consulted when attempting to place workloads on hosts. Preferably, the compute infrastructure provider implements one or more plans, wherein a plan defines an amount of CPU, RAM, disk, and network ingress/egress to which a VM is entitled when a compute service is purchased. Plans can be “shared,” meaning the resources are shared amongst other shared plans in an oversubscribed fashion, or “dedicated,” meaning CPU and RAM resources for a VM are dedicated. Generally speaking, and in response to a customer provisioning request, the allocator 612 checks whether the plan type for a selected plan has capacity on the host. In this example, the allocator has determined that a VM is configurable on the edge machine. It then inserts one or more jobs into the database 504 with a Host Identifier (Host ID) uniquely associated with the compute host engine 608 running on the edge machine.

In this example, the watchdog function 614 is responsible for waking up the host engine and instructing it to look for new work. In response, the host engine reaches out over the internet network 609 and finds the new job. The dispatch function 616 receives the job and manages the provisioning of the virtual machines 620. The status function 618 reports back its progress. Generalizing, the compute host engine creates the new VM, sets up its associated volumes and networks, and boots the VM, e.g. using QEMU running locally.

One technique to facilitate deploying or instantiating new overlay network edge regions with compute enabled involves mapping those regions (e.g., using DNS-based mapping, or an Anycast architecture) with respect to an existing compute datacenter. Several options exist to map overlay network edge regions to a datacenter, namely, as a single edge machine region, as an ECOR (a set of such regions), some arbitrary set of regions, perhaps one per-ECOR in an availability zone topology, and as a larger set of regions (or perhaps all regions) as a single compute “edge” datacenter. In one non-limiting embodiment, a region comprises a single rack that shares one or more (and preferably a pair of ToRs) with typically a large number (e.g., more than 20) Hosts, and multiple regions in the same ECOR are within a Datacenter (DC).

The above-described Generalized Edge Compute solution enables customers to deploy their applications in a VM environment hosted on overlay network hardware and software, thereby leveraging all of the advantages provided by a widely-distributed overlay. The approach enables customers (whether CDN, compute, or both) to host bandwidth-intensive applications, generate Web-like traffic, mix both traffic patterns, and to implement new traffic profiles. In addition, the solution provides a multi-tenant approach to hosting multiple customer VMs onto edge network hardware, and GEC customers can run any type of workload at any time while leveraging all the benefits of the edge network.

### Out of Band Access to Virtual Machines

With the foregoing by way of context, systems and methods for offering compute customers with alternative access and control of their VMs is now described.

Once a VM is created for a customer, the platform assigns the VM a public IP address, which the customer's administrative users can use to access it. This IP address is different from the IP address of the host on which the VM is running. As mentioned earlier, it is known to provide an alternative methodology for the customer to access and control their VM. There are several known ways in the prior art for a cloud computing platform to provide such an out-of-band access and control mechanism, as described in the Background section. The teachings hereof present new and improved techniques for doing so.

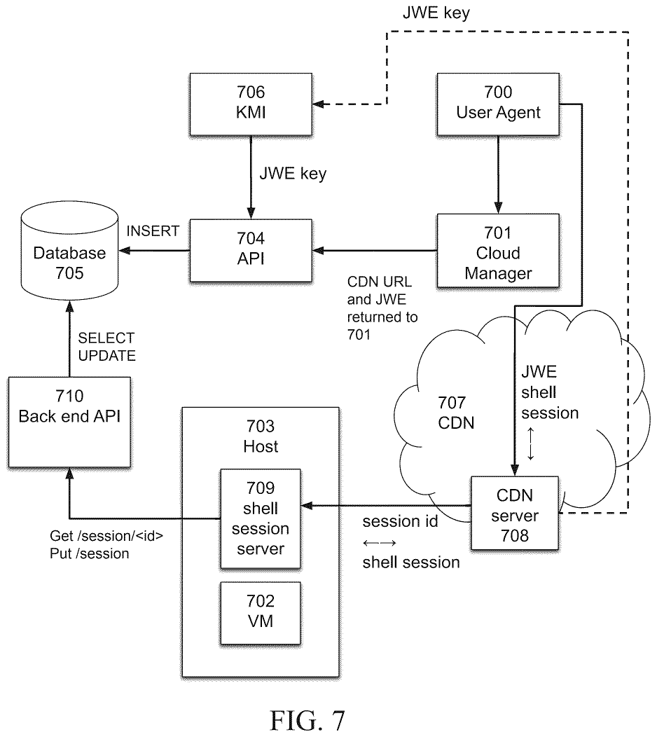

FIG. 7 illustrates a representative implementation. The components of the system that is shown in FIG. 7 include:
A user agent 700 (e.g., browser)
Cloud Manager 701, a web based UI, which may be implemented as described in connection with labels 306/507, as modified by the teachings below and otherwise in this document.
VM 702, which may be implemented as described in connection with labels 300/503/622, as modified by the teachings below and otherwise in this document. Note that the VM is an example, the teachings hereof can be applied to other virtualized resources such as dockers or containers.
A host 703, which may be implemented as described in connection with labels 502/600, as modified by the teachings below and otherwise in this document.
An API 704, which may be implemented as described in connection with API 501 and is part of the control plane shown in FIG. 5.
A database 705, which may be implemented as described in connection with labels 504/610, as modified by the teachings below and otherwise in this document.
A key management infrastructure (KMI) 706, which may be implemented in known ways such as described in U.S. Pat. Nos. 7096266 B2 and 11418352 B2, the contents of which are hereby incorporated by reference in their entirety, as modified by the teachings below and otherwise in this document.
An overlay network configured as a CDN 707, which may be implemented as described in connection with label 100 and FIG. 1, as modified by the teachings below and otherwise in this document.
A CDN server 708, which may be implemented as a proxy server as described in connection with label 102, as modified by the teachings below and otherwise in this document.
A shell session server 709, which may be implemented in the manner described in the Background as modified by the teachings below and otherwise in this document.
A back end API 710, which may be implemented as described in connection with label 508, as modified by the teachings below and otherwise in this document.

Note that the arrows in FIG. 7, specifically, represent connections between components and the direction of the arrows indicate which component initiates the connection (more specifically, which plays the role of client and which plays the role of a server) so as to help illustrate a workflow. Data flow on the connections may be bi-directional.

A representative workflow proceeds as follows. A user connects to a web based cloud manager 701 with their user agent (e.g., browser) 700 running on their client device. The user authenticates to the cloud manager using conventional techniques (e.g., presenting credentials and multi-factor authentication techniques), and using the Cloud Manager 701 UI requests an administrative shell to one of their VMs. In this diagram, the VM that the user wants to reach is depicted as VM 702 hosted on GEC host 703.

Responding to this shell session request, Cloud Manager 701 makes a request to API 704, which is coupled to the database 705. The API 704 generates a JSON Web Encryption (JWE) token encrypted with a JWE key from key vault 706 that is associated with the compute platform, or alternatively a JWE key specifically associated with this user and/or the user' organization. The API 704 inserts the shell session ID into the database 705.

The API 704 can encrypt several pieces of information into the JWE. One is the address of the host 703 for the VM 702 (e.g., its administrative IP address), another is the identifier for the VM 702 that the user wants to access (e.g., the platform's identifier for the guest VM). A third is the shell session ID. The shell session ID is an authenticator used to establish (or resume) a session and hence can be implemented as a sensitive bearer token. Shell sessions run within a screen or VNC instance per VM via the shell session server 709.

Preferably, the API 704 inserts the token into a URL as, e.g., a URL parameter (or pathname). The hostname for that URL points to a CDN 707. The API 704 returns this URL with the JWE to the cloud manager 701.

The cloud manager 701 directs the customer's user agent 700 to the URL returned from the API 704. (Alternatively, the cloud manager can establish a forward connection based on the URL and proxy the connection to the user agent 704.)

As mentioned, the hostname in the URL points to the CDN, which means that the hostname must be resolved to an IP address of one of the CDN servers 708 through the DNS system, as known in the art. The resolution process thus leverages the mapping and request routing infrastructure of the CDN to direct the user agent 700 to a selected CDN server 708. The user agent 700 is given the IP address of a specific CDN server machine 708 that is nearby (in network distance terms) and not overloaded CDN server 708. (Note that in an alternative embodiment, the IP address may be an Anycast IP address.)

The user agent 700 connects to the CDN server 708 and sends an HTTP Get request for the URL. In response, the CDN server 708 looks up its content handling rules (configuration) for this hostname property. According to this disclosure, CDN servers in the CDN 707 (including CDN server 708) have been configured with special configuration instructions for this hostname, as it is essentially associated with a control plane of the cloud computing platform. These special configuration instructions can be distributed via the control plane for the CDN (see 120 in FIG. 1 and associated description) using conventional techniques.

The instructions tell the CDN server 708 to obtain the appropriate JWE key from the CDN's key management infrastructure. The CDN server 708 uses the key to decrypt the embedded token and recover the information therein. Preferably, the configuration also instructs the CDN server 708 not to log the URL because it contains the token, unlike typical CDN server operation for delivery of third party content. In one implementation, the token can be passed in a field of the HTTP and/or Websockets upgrade messages that will not be logged in the normal course of operation.

With the administrative IP address for the host 703 from the decrypted JWE, the CDN server 708 goes forward to the host 703, which resides in one of cloud compute platform data centers (e.g., as described for labels 310, 502, FIG. 4). The CDN server 708 connects to the shell session server 709. An instance of the shell session server 709 runs as a process on every host in the compute platform, and it provides access to the guest VMs running locally.

The CDN server 708 sends the shell session server 709 the shell session ID and the identifier for the VM that the user is authorized to access. (Alternatively, the CDN server 708 could send the JWE to the shell session server 709, although in this approach shell session server 709 would need to get the JWE key and extract the information.) The shell session server 709 validates the session ID with the back-end API 710. It then connects to the appropriate port of the VM for the type of shell session desired. As mentioned earlier, for a text based console the shell session server 709 can connect to the serial port exposed by the GNU screen process of QEMU; while for a graphical interface the VNC socket exposed by QEMU can be used.

Thereafter the CDN server 708 proxies communications within the shell session between the VM 702 on the host 703 and the user agent 700. To handle two way communication on this channel, the communications can be implemented with HTTP messaging upgraded to Websockets. Websockets is a well known HTTP protocol upgrade that allows a client and server to exchange messages back and forth (in contrast to the single request-then-response style of HTTP). Websockets also provides a “protocols” field, which allows more specific “(sub-)protocols” to be negotiated between the client and server using HTTP headers. Those sub-protocols can be used to implement custom messaging protocols for the text or graphical interfaces to the VM in the shell session. Preferably, all connections between platform components, including between host 703 and CDN server 708, and between CDN server 708 and User Agent 700 are mutually authenticated, e.g., with certificate based authentication.

With the foregoing description in mind, some additional implementation details are now provided.

### JWE Format

As mentioned above, JWE stands for JSON Web Encryption, a well known standard for encrypting and authenticating JSON data. It is used to convey host and session information securely to the CDN server 708. In this context, “securely” means that a client (e.g., user agent 700) possessing a JWE token is unable to determine the host's IP address or other identifying information of the host machine and that the JWE tokens cannot be “forged” by adversaries to cause the CDN server 708 to connect to unexpected places.

In a representative implementation, the JWE can be constructed as follows:
JOSE header (unencrypted):
   “enc”: “A128CBC-HS256”- AES-128 in CBC mode with sha256 HMAC
   “kid”: <key_id>—key identifier; changed to accomplish key rotation, e.g., 1
   “exp”: <epoch>—epoch time (UTC) of expiration of the token
The (encrypted) payload is a JSON-encoded object with these keys:
   “connect”: “<. . . >”—The IP or hostname the CDN server 708 should use to connect to the host 703.
   “host”: “<. . . >”—The hostname CDN server 708 should use for origin SNI/Host Header/Cert validation.
   “shell session id”: “<id>”—The session identifier (random UUID-4 with the last N characters removed) to be forwarded to the host 703.

### Shell Session Server

An instance of a shell session server 709 runs on each compute host that has guest VMs. This server accepts an incoming TLS connection, extracts a session id from the request, validates it with the BAPI 710, accepts a websocket upgrade, initiates a backend process, and then transfers data between the backend process and the websocket connection. It runs in a host as a user process, not in a dedicated VM. The server can listen on a dedicated port for incoming requests. The server can also connect to the KMI 706 infrastructure to obtain certificates for the client and server connections. Preferably the server implements an access control list (e.g., IP ACL) restricting access to known CDN servers 708 in the CDN 707, as there is no reason for other machines to contact it for shell sessions.

### Cloud Manager and API Interfaces

It should be understood that in alternate embodiments, the API 704 could be configured to be exposed to the customer user agent 704. In such an approach, the user agent 700 might connect and authenticate directly to the API 704 to obtain the JWE and CDN URL.

### Computer Based Implementation

The teachings hereof may be implemented using conventional computer systems, but modified by the teachings hereof, with the components and/or functional characteristics described above realized in special-purpose hardware, general-purpose hardware configured by software stored therein for special purposes, or a combination thereof, as modified by the teachings hereof.

Software may include one or several discrete programs. Any given function may comprise part of any given module, process, execution thread, or other such programming construct. Generalizing, each function described above may be implemented as computer code, namely, as a set of computer instructions, executable in one or more microprocessors to provide a special purpose machine. The code may be executed using an apparatus—such as a microprocessor in a computer, digital data processing device, or other computing apparatus—as modified by the teachings hereof. In one embodiment, such software may be implemented in a programming language that runs in conjunction with a proxy on a standard Intel hardware platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

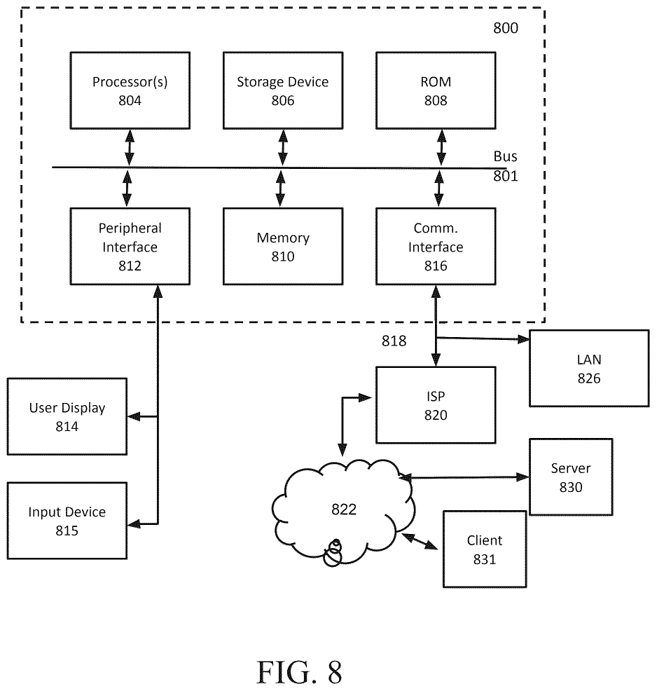

FIG. 8 is a block diagram that illustrates hardware in a computer system 800 upon which such software may run in order to implement embodiments of the invention. The computer system 800 may be embodied in a client device, server, personal computer, workstation, tablet computer, mobile or wireless device such as a smartphone, network device, router, hub, gateway, or other device. Representative machines on which the subject matter herein is provided may be a computer running a Linux or Linux-variant operating system and one or more applications to carry out the described functionality.

Computer system 800 includes a microprocessor 804 coupled to bus 801. In some systems, multiple processor and/or processor cores may be employed. Computer system 800 further includes a main memory 810, such as a random access memory (RAM) or other storage device, coupled to the bus 801 for storing information and instructions to be executed by processor 804. A read only memory (ROM) 808 is coupled to the bus 801 for storing information and instructions for processor 804. A non-volatile storage device 806, such as a magnetic disk, solid state memory (e.g., flash memory), or optical disk, is provided and coupled to bus 801 for storing information and instructions. Other application-specific integrated circuits (ASICs), field programmable gate arrays (FPGAs) or circuitry may be included in the computer system 800 to perform functions described herein.

A peripheral interface 812 may be provided to communicatively couple computer system 800 to a user display 814 that displays the output of software executing on the computer system, and an input device 815 (e.g., a keyboard, mouse, trackpad, touchscreen) that communicates user input and instructions to the computer system 800. However, in many embodiments, a computer system 800 may not have a user interface beyond a network port, e.g., in the case of a server in a rack. The peripheral interface 812 may include interface circuitry, control and/or level-shifting logic for local buses such as RS-485, Universal Serial Bus (USB), IEEE 1394, or other communication links.

Computer system 800 is coupled to a communication interface 816 that provides a link (e.g., at a physical layer, data link layer,) between the system bus 801 and an external communication link. The communication interface 816 provides a network link 818. The communication interface 816 may represent an Ethernet or other network interface card (NIC), a wireless interface, modem, an optical interface, or other kind of input/output interface.

Network link 818 provides data communication through one or more networks to other devices. Such devices include other computer systems that are part of a local area network (LAN) 826. Furthermore, the network link 818 provides a link, via an internet service provider (ISP) 820, to the Internet 822. In turn, the Internet 822 may provide a link to other computing systems such as a remote server 830 and/or a remote client 831. Network link 818 and such networks may transmit data using packet-switched, circuit-switched, or other data-transmission approaches.

In operation, the computer system 800 may implement the functionality described herein as a result of the processor executing code. Such code may be read from or stored on a non-transitory computer-readable medium, such as memory 810, ROM 808, or storage device 806. Other forms of non-transitory computer-readable media include disks, tapes, magnetic media, SSD, CD-ROMs, optical media, RAM, PROM, EPROM, and EEPROM, flash memory. Any other non-transitory computer-readable medium may be employed. Executing code may also be read from network link 818 (e.g., following storage in an interface buffer, local memory, or other circuitry).

It should be understood that the foregoing has presented certain embodiments of the invention but they should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought.

It is noted that any trademarks appearing herein are the property of their respective owners and used for identification and descriptive purposes only, and not to imply endorsement or affiliation in any way.

1. A method, comprising:
communicating with a user agent to authenticate a user;
responsive to successful authentication, providing the user agent with (a) a URL and (b) an encrypted token;
directing the user agent to a content delivery network (CDN), the CDN comprising a plurality of proxy servers distributed across the Internet;
at a particular proxy server in the CDN, receiving a request from the user agent, the request comprising the URL and the encrypted token;
associating the URL with a configuration for a cloud computing platform, the configuration instructing the particular proxy server to handle the request by:
decrypting the encrypted token to obtain a network locator for a host in the cloud computing platform, the host having a plurality of virtual resources running locally,
using the second network locator, going forward to the host, and
providing a secure communication channel from the user agent to the host, and within that secure communication channel, present) an identifier for a particular virtual resource in the plurality of virtual resources machines that the user is authorized to access;
wherein the host communicates with the particular virtual resource to provide the user with a control interface to the particular virtual resource.

2. The method of claim 1, wherein each of a plurality of hosts in the cloud computing platform runs a service that provides a secure communication channel for any of the plurality of virtual machines running locally.

3. The method of claim 1, wherein the communication with the user agent to authenticate the user is performed through a web-based control center for a multi-tenant platform providing virtual resources.

4. The method of claim 1, further comprising: the CDN providing a request routing mechanism to direct the user agent to the particular proxy server.

5. The method of claim 1, wherein the URL comprises a hostname that is resolved to an IP address associated with the particular proxy server in the CDN.

6. The method of claim 4, wherein the hostname is resolved through a DNS system associated with the CDN.

7. The method of claim 1, wherein the encrypted token is within at least one of: (i) an HTTP header, (ii) a websockets frame, and (iii) the URL.

8. The method of claim 1, wherein the network locator comprises any of a hostname and an IP address.

9. The method of claim 1, wherein the virtual resources comprise virtual machines.

10. The method of claim 1, wherein the control interface accepts a command from the user agent and sends a response of the particular virtual resource to the command.

11. The method of claim 1, wherein the network locator for the host is not publicly routable.

12. The method of claim 1, wherein the identifier is presented in encrypted form.

13. A system, comprising:
at least one of a (i) cloud manager web application and (ii) user API operable to:
communicate with a user agent to authenticate a user;
responsive to successful authentication, provide the user agent with (a) a URL and (b) an encrypted token;
direct the user agent to a content delivery network (CDN), the CDN comprising a plurality of proxy servers distributed across the Internet;
a particular proxy server in the CDN operable to:
receive a request from the user agent, the request comprising the URL and the encrypted token;
associate the URL with a configuration for a cloud computing platform;
based on the configuration,
decrypt the encrypted token to obtain a network locator for a host in the cloud computing platform, the host having a plurality of virtual resources running locally,
use the second network locator, going forward to the host, and
provide a secure communication channel from the user agent to the host, and within that secure communication channel, present) an identifier for a particular virtual resource in the plurality of virtual resources machines that the user is authorized to access;
wherein the host communicates with the particular virtual resource to provide the user with a control interface to the particular virtual resource.

14. The system of claim 13, wherein the URL comprises a hostname that is resolved to an IP address associated with the particular proxy server in the CDN.

15. The system of claim 14, wherein the hostname is resolved through a DNS system associated with the CDN.

16. The system of claim 13, wherein the encrypted token is within at least one of: (i) an HTTP header, (ii) a websockets frame, and (iii) the URL.

17. The system of claim 13, wherein the network locator comprises any of a hostname and an IP address.

18. The system of claim 13, wherein the virtual resources comprise virtual machines.

19. The system of claim 13, wherein the control interface accepts a command from the user agent and sends a response of the particular virtual resource to the command.

20. The system of claim 13, wherein the network locator for the host is not publicly routable.
